(19) United States
(12) Patent Application Publication
(10) Pub. No.: US 2008/0059385 A1
(43) Pub. Date: Mar. 6, 2008

(54) HIGH-THROUGHPUT ENVELOPE STUFFER LINE INCORPORATING A POSTAGE METER

(75) Inventors: Romain Pillard, Avon (FR); Veronique Vaissiere, Palaiseau (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, French Limited Company, Bagneux (FR)

(21) Appl. No.: 11/838,381

(22) Filed: Aug. 14, 2007

(30) Foreign Application Priority Data
Aug. 31, 2006 (FR) 0653525

(51) Int. Cl. G07B 17/02

(52) U.S. Cl. 705/401

(57) ABSTRACT

A facility made up of a high-throughput envelope stuffer line for stuffing envelopes, at the end of which line an inkjet postage meter is disposed that is designed to co-operate with said high-throughput envelope stuffer line, the inkjet postage meter being provided with a visual signaling device comprising, fixed to a mast extending above the inkjet postage meter, signaling lights having at least three distinct colors, each color corresponding to a determined operating state through which the inkjet postage meter passes successively.

### FIELD OF THE INVENTION

The present invention relates to the field of mail handling, and it relates more particularly to a high-throughput envelope stuffer line at the end of which an inkjet postage meter or “franking machine” is disposed.

### PRIOR ART

High-throughput or very high throughput envelope stuffers, i.e. stuffers that can process in excess of 15,000 envelopes per hour, are well known and are used mainly by “dispatchers” who send bulk mail in very large runs for government agencies or large businesses, in particular mail order businesses.

Generally, at the end of the envelope stuffer line that can extend over more than five meters, a postage meter is provided for printing a postage mark on each envelope. Unfortunately current postage meters of the inkjet type require regular preventive maintenance operations in order to avoid postage meter breakdown which would require a corrective maintenance operation. In particular, provision is made to clean the print heads frequently so as not to degrade the quality of printing of the postage marks. Each time the print heads are cleaned, it is thus necessary to stop the postage meter and thus to stop the suffer line. That constraint did not exist with prior art mechanical postage meters on which an operator was rarely obliged to take action, and with which productivity losses due to stuffer line stoppages were therefore very limited.

In addition, also for productivity reasons, it is not possible to assign one specific operator to the postage meter. It is thus the operator in charge of overseeing the stuffing operations who, although that operator is a long way away from the postage meter, must take any necessary action on the postage meter, and such action must not put unreasonable constraints on the operator, and in particular must not oblige the operator to be continually going to tend the postage meter.

### OBJECT AND DEFINITION OF THE INVENTION

An object of the present invention is thus to provide a high-throughput envelope stuffer line associated with a postage meter that makes it possible to minimize action from the operator of the stuffer line or, when such action is necessary, to facilitate it. Another object of the invention is also to make operation of the stuffer line and of the postage meter mutually compatible and, as far as possible, to limit stoppages of them.

These objects are achieved by a high-throughput envelope stuffer line for stuffing envelopes, at the end of which line a postage meter is disposed that is designed to co-operate with said high-throughput envelope stuffer line, wherein said inkjet postage meter is provided with a visual signaling device comprising, fixed to a mast extending above the postage meter, signaling lights having at least three distinct colors, each color corresponding to a determined operating state through which the postage meter passes successively.

Thus, with this particular configuration of the facility comprising the stuffer line and the postage meter, the operator of the stuffer line, who generally wears ear protectors while working, as required by regulations, is informed simply and very rapidly of the imminence of stoppage of the postage meter, and can, by means of the high level of visibility offered, anticipate what action is needed, and act accordingly on the stuffer line or on the postage meter in a manner such as to correct an error, or at least such as to take the necessary steps to avoid any state that is detrimental for the facility.

Preferably, said mast constitutes a peripheral of the inkjet postage meter, and one of said colors corresponds to an imminent stoppage of the inkjet postage meter. Such stoppage occurs, in particular, prior to cleaning or changing print heads or prior to filling the ink reservoir.

Advantageously, one color changes to another on the basis of a counter that counts the number of envelopes franked, or on the basis of a time delay.

The present invention also relates to a peripheral of a postage meter, which peripheral is advantageously of the “plug and play” type, said peripheral constituting a visual signaling device comprising, fixed to a mast extending above the postage meter, signaling lights having at least three distinct colors, each color corresponding to a determined operating state through which the postage meter passes successively.

### BRIEF DESCRIPTION OF THE DRAWINGS

The characteristics and advantages of the present invention appear more clearly from the following description given by way of non-limiting indication, and with reference to the accompanying drawings, in which:

FIG. 1 is a perspective view of a stuffer line incorporating a postage meter of the invention; and

FIG. 2 is a flow chart showing the various operating states of the postage meter of FIG. 1.

### DETAILED DESCRIPTION OF A PREFERRED EMBODIMENT

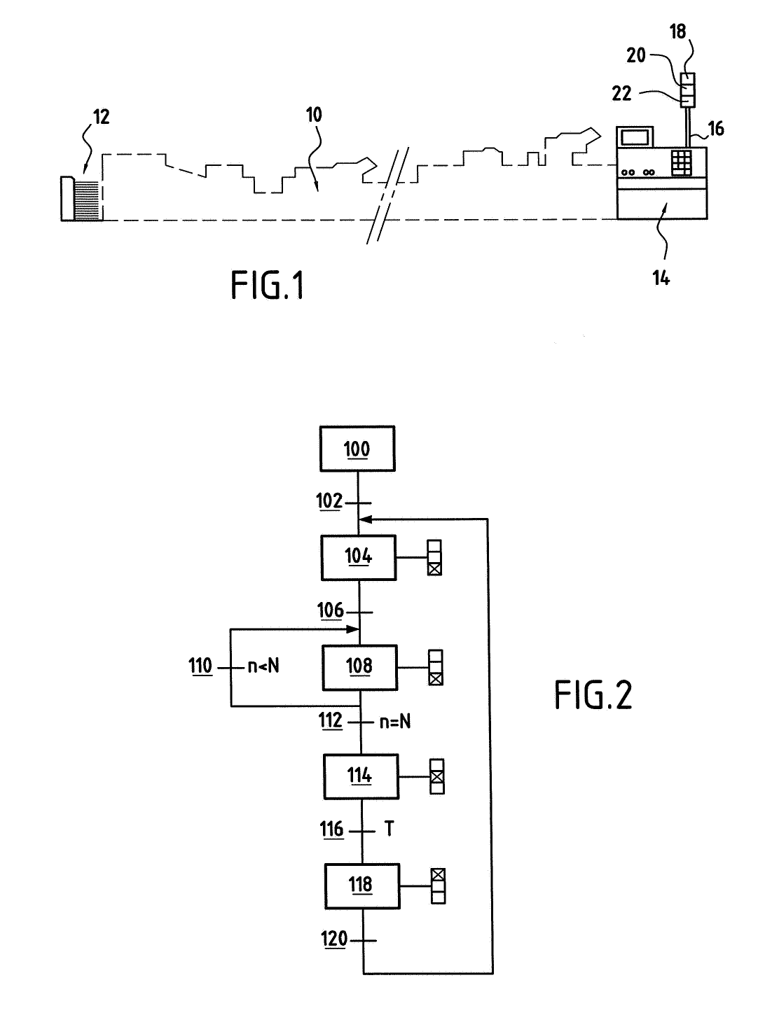

FIG. 1 shows a high-throughput envelope stuffer line incorporating a postage meter of the invention.

The stuffer facility 10 is fed with a stack of envelopes 12 and has a conventional structure that does not require any detailed description. Each envelope is to be stuffed with one or more documents (not shown), optionally after some of said documents have been folded. At the end of said stuffer facility, a postage meter 14 is disposed that, in accordance with the invention, is provided with a specific visual signaling device 16 which constitutes a peripheral of the postage meter, in the manner of postal scales, for example, and is thus connected to said postage meter via an input/output connector thereof. More particularly, said peripheral can be of the plug-and-play type and can thus be put in place or removed without interrupting operation of the postage meter.

The visual signaling device is constituted by a mast 16 having a top portion that extends above the postage meter and that is provided with three superposed signaling lights of different colors, advantageously a red light 18, an amber light 20, and a green light 22, each light representing a particular operating state of the postage meter, as described in more detail below. The mast is powered directly from an external power supply network (not shown) that is typically a single-phase network or a three-phase network, or indeed from the postage meter. Successive triggering of the signaling lights is controlled from the postage meter on the basis of information delivered by said postage meter and concerning some of its operating states.

FIG. 2 is a flow chart showing how the signaling lights operate depending on the state of the postage meter. As is known, the blocks represent successive states of the postage meter and the dashes between the blocks represent events that must occur in order to go from one operating state to another.

With the postage meter initially stopped or “off” 100, action on a start or “on” button 102 causes the postage meter to go to a state 104 corresponding to the motor being switched on and to the green signaling light being switched on, and, preferably, to the stuffer facility being switched on. On arrival of the first leading edge of an envelope (event 106), the postage meter goes to an operating state 108 in which printing can be performed, and it remains in this state so long as a predetermined number N of envelopes has not been printed (event 110). In this state, the green signaling light remains green. Once said predetermined number has been reached (event 112), the postage meter goes to a state 114 corresponding to imminent cleaning of the print heads, indicated by the amber signaling light. The signaling lights changing from green to amber makes it possible, by indicating to the operator that the print head cleaning operation is imminent, for the operator to stop the stuffer facility 10 and thus to avoid any jamming at the postage meter 14 due to said facility being stopped too late. After a time delay T has elapsed (or after any event of an equivalent duration such as franking a number k of envelopes has occurred) (event 116) that is sufficient for the operator to stop the facility as soon as the amber signaling light comes on, the motor of the postage meter is stopped as is printing of the envelopes still in the conveyor path of the postage meter (state 118), the number of envelopes and the time delay are reinitialized, and the red signaling light is switched on, indicating that the print heads are going over to a maintenance position for the purpose of cleaning them. Throughout the cleaning operation, the signaling lights remain red, and it is only once the print heads resume their initial position, after said cleaning (event 120), that the postage meter returns to its state 104 with the motor being switched and the green signaling light being switched on, inviting the operator also to switch the stuffer facility back on, unless it is switched back on automatically.

It can be noted that the succession of light changes makes it possible to anticipate error correction, it not being possible for a red signaling light to appear after a green signaling light, without going through an amber signaling light.

In addition, it should be noted that, although the above operation is described with reference to cleaning print heads, clearly any other maintenance operation on the postage meter, such as replacing the print head or filling its ink reservoir, can take place using the same process of successively signaling to the operator. For example, an ink level sensor (instead of the envelope counter) can indicate that the reservoir is going to run out of ink imminently, and can cause the green light to change to the amber light, with the red light coming on as above after a time delay. If it is desired to implement the two possibilities simultaneously, it is possible, for example to imagine duplicating the amber signaling light with a yellow signaling light so that the operator is informed visually which maintenance operation is to be performed, namely cleaning the print heads (amber light) or filling the ink reservoir (yellow light).

Thus, with the present invention and with the lights changing successively from green to red, through amber (or yellow), the operator can thus access the state of the postage meter without having continually to go to it. Visual signaling, which is particularly suitable in view of the high level of ambient noise to which the operator is subjected, thus makes it possible to obtain a diagnostic on the state of the postage meter without wasting any time, and without being surprised. In view of the succession of light changes, the blocking states are anticipated and productivity loss is reduced very significantly by enabling the throughput of the stuffer line to be sustained.

What is claimed is:

1. A facility made up of a high-throughput envelope stuffer line for stuffing envelopes, at the end of which line an inkjet postage meter is disposed that is designed to co-operate with said high-throughput envelope stuffer line, wherein said inkjet postage meter is provided with a visual signaling device comprising, fixed to a mast extending above the inkjet postage meter, signaling lights having at least three distinct colors, each color corresponding to a determined operating state through which the inkjet postage meter passes successively.

2. A facility according to claim 1, wherein said mast constitutes a peripheral of the inkjet postage meter.

3. A facility according to claim 1, wherein one of said colors constitutes a signal indicating imminent stoppage of the inkjet postage meter.

4. A facility according to claim 1, wherein one color changes to another on the basis of a counter that counts the number of envelopes franked.

5. A facility according to claim 1, wherein one color changes to another on the basis of a time delay.

6. A peripheral of an inkjet postage meter disposed at the end of a high-throughput envelope stuffer line, said peripheral constituting a visual signaling device comprising, fixed to a mast extending above the inkjet postage meter, signaling lights having at least three distinct colors, each color corresponding to a determined operating state through which the inkjet postage meter passes successively.

7. A peripheral according to claim 6, having an interface of the “plug-and-play” type.
